(19) United States
(12) Patent Application Publication
(10) Pub. No.: US 2010/0020699 A1
(43) Pub. Date: Jan. 28, 2010

(54) METHOD AND APPARATUS FOR OAM & P OF WIRELESS NETWORK

(76) Inventor: Hanson On, San Diego, CA (US)

Correspondence Address: Patentique PLLC, P.O. Box 5803, Bellevue, WA, 98006, US

(21) Appl. No.: 12/473,125

(22) Filed: May 27, 2009

Related U.S. Application Data
(60) Provisional application No. 61/073,309, filed on Jun. 17, 2008.

(51) Int. Cl. H04J 1/16; H04W 4/00

(52) U.S. Cl. 370/241.1; 370/338

(57) ABSTRACT

There is provided a system and method of operating, administering, managing and provisioning of a communications network. A network element enters the registration and discovery mode during its initial auto-configuration, restarting, restarting from different geological location, or forming peer-to-peer groups for self-organized and/or self-coordinated networks. Managing mode is entered after the network element completes its registration with the registrar server.

This non-provisional application claims benefit to U.S. Provisional Application No. 61/073,309, which is hereby incorporated by reference as if fully set forth.

### FIELD OF THE INVENTION

The present invention relates to methods and apparatuses for operation administration and management of communications networks and is particularly concerned with multi-vendor wireless networks.

### BACKGROUND OF THE INVENTION

Every wireless communication service provider has its own management infrastructure for its service networks' Operation, Administration, Maintenance and Provisioning (OAM&P). The management infrastructure is designed to manage many different types of networks such as radio access networks, exchanges, transmission networks, area networks, intelligent nodes and substantial amount of computer hardware/software. The different types of network elements are generally supported with unique vendor specific management systems according to:
Radio Access Technologies (RAT);
Coverage footprints;
Transmission network technologies;
Network interfaces;
Signaling mechanisms;
Locations;
Equipment vendors.

As a result, duplicate management applications are supplied by different vendors implemented with proprietary interfaces and protocols. The heterogeneous nature of the wireless communication networks has made the OAM&P of the service network ever challenging and costly. The 3rd Generation Partnership Project (3GPP), standard body for UMTS, has recognized the problems and summarized them as follows:
Architectures vary greatly in scope and detail;
There exist legacy systems and applications;
Heterogeneous radio network presents a number of operational difficulties for the service providers on enabling effective and efficient network management;
Application and functional blocks are not re-usable.

There have been efforts to standardize the most important and strategic context and server as a framework to help define a physical architecture. However, most of the efforts, so far, have been on underlining communication interfaces (e.g. Q or X interfaces) instead of providing a common platform capable of handling centralized and distributed management transaction as well as independent of RAT, coverage footprints, transmission network topologies, network interfaces, signalling mechanisms, locations and equipment vendors.

The architecture of the network management system is very complex and can vary greatly in scope and detail. It does not seem possible to have a single architecture that can meet all the needs from different service providers.

Some solutions choose the approach of divide-and-conquer by solving the costly and resource intensive management tasks one at a time. Once a task is identified, a management platform is defined and, likely, supported by new management protocols.

The task can be managing a network element at the edge of a service network or within a network segment. One example is the deployment and management of a Wide Area Network (WAN) Customer Premises Equipment (CPE), e.g. Digital Subscriber Line (DSL) modem. Another example is the deployment and management of cellular network base stations (e.g. pico-cell or femtocell).

### WAN Example

The deployment and management of a DSL modem in a WAN involves configuration and dynamic service provisioning, software/firmware image management, status and performance monitoring, and diagnostics.

The DSL Forum, which was later renamed as Broadband Forum, has defined a transport layer communication protocol between CPE and Auto-Configuration Server (ACS), namely Technical Report 069 (TR-069) CPE WAN Management Protocol. TR-069 provides a centralized management platform that allows the ACS to manage multiple CPEs remotely, periodically and simultaneously.

It serves the TCP/IP based LAN/WAN CPEs well utilizing point-to-point client-server transaction model between CPE and the ACS. However, it is limited to management of TCP/IP based CPEs and it does not offer point-to-multi-point peer-to-peer transactions.

### Cellular Example

The deployment and management of a femtocell in a cellular network involves configuration and dynamic service provisioning, Radio Frequency (RF) power measurement, QoS and interference coordination, software/firmware image management, status and performance monitoring, and diagnostics.

The Femto Forum has adopted TR-069 as the basis for the management protocol for femtocells. TR-069 is sufficient for configuration and dynamic service provisioning, software/firmware image management, status and performance monitoring, and diagnostics so long as the femtocells have IP based broadband connectivity (LAN/WAN) for their backhaul traffic.

However, the femtocell management requirements go well beyond what the TR-069 has covered, for example RF power measurement, QoS and interference coordination. In addition, TR-069 does not address the communication mechanism for femtocells utilizing none IP based backhaul connectivity.

In a smaller cell dominated environment where picocells, femtocells, and microcells are deployed in high density with great overlap, such as 3.5G or 4G networks, self-organized networking (SON) capability and coordination between the basestastions are essential, thus a communication platform proposed in this invention is required.

Systems and methods disclosed herein provide for operation administration and management of communications networks to obviate or mitigate at least some of the aforementioned disadvantages.

### SUMMARY OF THE INVENTION

An object of the present invention is to provide a framework for operation administration and management of communications networks as well as self organized networking (SON).

In accordance with an aspect of the present invention there is provided a system for operating, administering, managing and provisioning of a communications network comprising a network element in a first network, for each network element, an element agent residing on the network element, e.g. user agent if SIP is used an interface for coupling the first network to a second network and a registrar in the second network for registering each element agent.

In accordance with another aspect of the present invention there is provided a method of operating, administering, managing and provisioning of a communications network, the method comprising the steps of enabling each network element in a first network to communicate with a server in a second network, interfacing each network element in the first network with the second network and sending a message from a selected network element of the first network to the second network for at least one of operating, administering, managing and provisioning the selected network element.

In accordance with another aspect of the present invention there is provided a system for SON comprising network elements in a first network and interfaces for coupling the network elements to the first network.

In accordance with another aspect of the present invention there is provided A method of SON communications, the method comprising the steps of enabling each network element in a first network to communicate with other network elements in the first network, interfacing other network elements in the first network and sending a message from a selected network work element of the first network to at least one other selected network element in the first network.

The network manages applications without the specific knowledge of the radio access technologies, coverage footprints, transmission network topologies, network interfaces, signaling mechanisms and equipment vendors. In addition, it has the flexibility to adapt to the dynamics of the environment and sustain for future expansion.

The present invention provides a common platform for network management applications by utilizing existing networks (e.g. WAN, LAN, cellular, Wi-Fi etc.) and standard communication protocols (e.g. SIP, TCP/IP, SMS, GSM, GPRS, EDGE, CDMA, WCDMA, LTE, WiMax etc.). The present invention defines the transportation mechanism for the network management traffic from the application layer down to the physical layer.

The present invention allows centralized and distributed management models. In addition, it allows client-server, peer-to-peer, point-to-point and point-to-multi-point transactions.

### BRIEF DESCRIPTION OF THE DRAWINGS

The present invention will be further understood from the following detailed description with reference to the drawings in which:

FIG. 1 illustrates an example (Femtocell) to which embodiments of the present invention are applied;

FIG. 2 illustrates a network element deployed with a LAN interface in accordance with a first embodiment of the present invention;

FIG. 3 illustrates a network element deployed with a WAN interface in accordance with a second embodiment of the present invention;

FIG. 4 illustrates a network element deployed with a fixed wireless interface in accordance with a third embodiment of the present invention;

FIG. 5 illustrates a network element deployed with a cellular and or cellular SMS network interface in accordance with a fourth embodiment of the present invention;

FIG. 6 illustrates a session based self-organized and/or self-coordinated network in accordance with a fifth embodiment of the present invention;

FIG. 7 illustrates a registration and authentication message sequence chart for a LAN/WAN interfaced network element of FIGS. 2 and 3;

FIG. 8 illustrates a registration and authentication message sequence chart for a fixed wireless network or cellular data network interface network element of FIG. 4;

FIG. 9 illustrates a registration and authentication message sequence chart for a cellular SMS network interfaced network element of FIG. 5;

FIG. 10 illustrates a provisioning message sequence chart for a LAN/WAN interfaced network element of FIGS. 2 and 3;

FIG. 11 illustrates a provisioning message sequence chart for a fixed wireless network or cellular data network interface network element of FIG. 4;

FIG. 12 illustrates a provisioning message sequence chart for a cellular SMS network interfaced network element of FIG. 5;

FIG. 13 illustrates a discovery message sequence chart for a LAN/WAN interfaced network element of FIGS. 2 and 3;

FIG. 14 illustrates a discovery message sequence chart for a fixed wireless network or cellular data network interface network element of FIG. 4;

FIG. 15 illustrates a discovery message sequence chart for a cellular SMS network interfaced network element of FIG. 5; and

FIG. 16 illustrates a protocol stack in accordance with an embodiment of the present invention.

### DETAILED DESCRIPTION OF THE PREFERRED EMBODIMENT

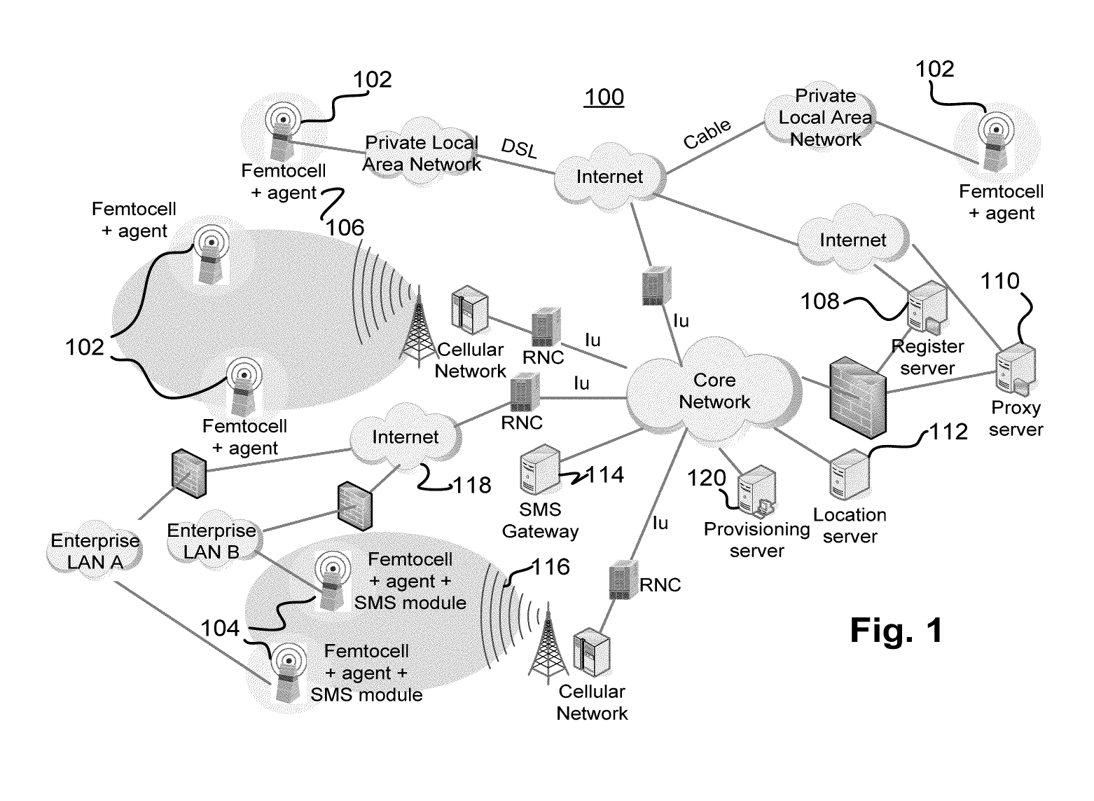

Referring to FIG. 1 there is illustrated a femtocell topology 100 that uses embodiments of the present invention. The deployment of femtocells in cellular networks has introduced many new challenges to network management. The challenges begin with the potential deployment volume to the dynamics of the coverage footprints and to various backhaul connection interfaces. FIG. 1 illustrates some possible femtocell network architectures. For example femtocells 102 include element agents and femtocells 104 include element agent (EA) and a SMS module.

The embodiments of the present invention include the following components in the network infrastructure as network elements:
Element agent (EA) 106;
Registrar 108;
Location server 112;
Proxy server 110.

The following components are optional and deployed for additional services, e.g. element redirection, SMS service etc.
Redirect server (not shown in FIG. 1);
SMS gateway 114;
Dynamic DNS server (not shown in FIG. 1).

The EA 106 is usually part of a managed network element 102 (e.g. femtocell, CPE etc.) and responsible for the management signals' (request and response generated from management applications) transmission and reception. In addition, the EA 106 registers the network element 102 with the registrar 108. The registrar 108 is responsible for handling the registration of the EAs 106 and forwarding the location information to the location server 112. The redirect server assists the proxy server 110 in locating EAs 106 with alternative locations. The proxy server 110 is responsible for request and response routing, authentication and service provider specific features. The location server 112 maintains EA location information (e.g. IP address, phone number, GPS location). The location information, at a minimum, has to be sufficient to allow the proxy server 110 to route the request or response to its destination successfully. If the GPS location information is also included in the location database, it can be used for other management purposes, such as forming interference management groups or QoS coordination groups. The SMS gateway 114 is responsible for routing request and response between cellular SMS network and IP network, for example 116 and 118, respectively. The dynamic DNS server is to handle the femtocell or CPE that is utilizing Dynamic Host Configuration Protocol (DHCP).

In addition, the network element (e.g. femtocell) under management includes the following components:
EA;
EA request and response transceiver.

The EA request and response transceiver is to provide the network element an alternative network management signaling channel that is not always IP dependent. The transceiver can be LAN, WAN or cellular UE module.

The following components are optional and deployed to handle network element using dynamic or private IP address.
DNS update client;
NAT traversal and application level gateway.

The DNS update client and the NAT traversal and application level gateway help resolve IP packet routing to private IP addresses.

To minimize the deployment and management cost, the embodiments of the present invention establishes a secure and stable transportation mechanism for network management signaling and provide network management applications a single Application Programming Interface (API).

The embodiments of the present invention are designed to operate in three modes:
Registration;
Discovery mode; and
Managing mode.

A network element enters the registration and discovery mode during its initial auto-configuration, restarting, restarting from different geological location, or forming peer-to-peer groups for self-organized and/or self-coordinated networks. Managing mode is entered after the network element completes its registration with the registrar server 106.

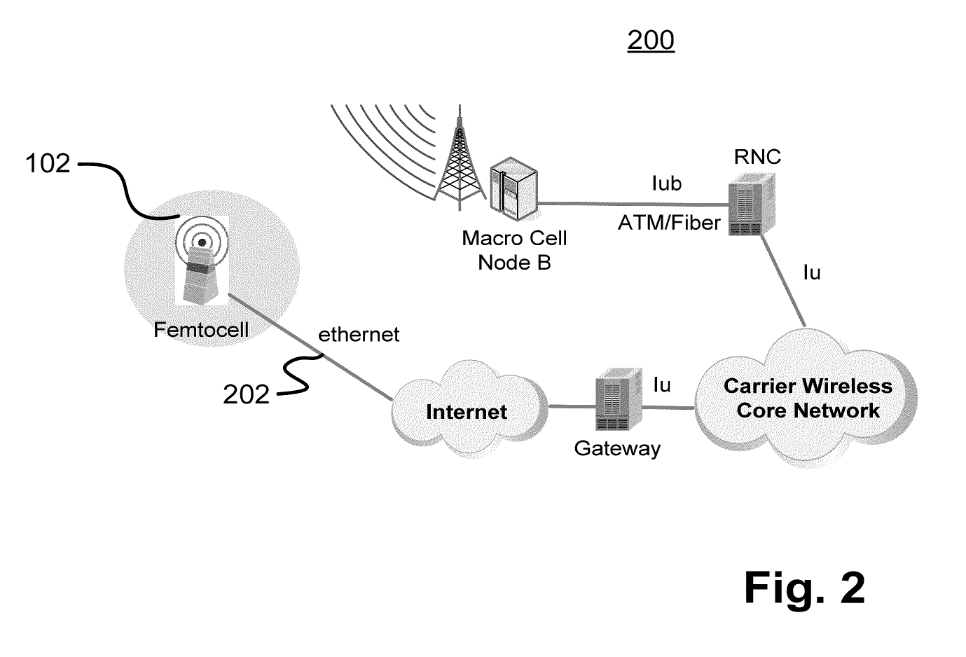

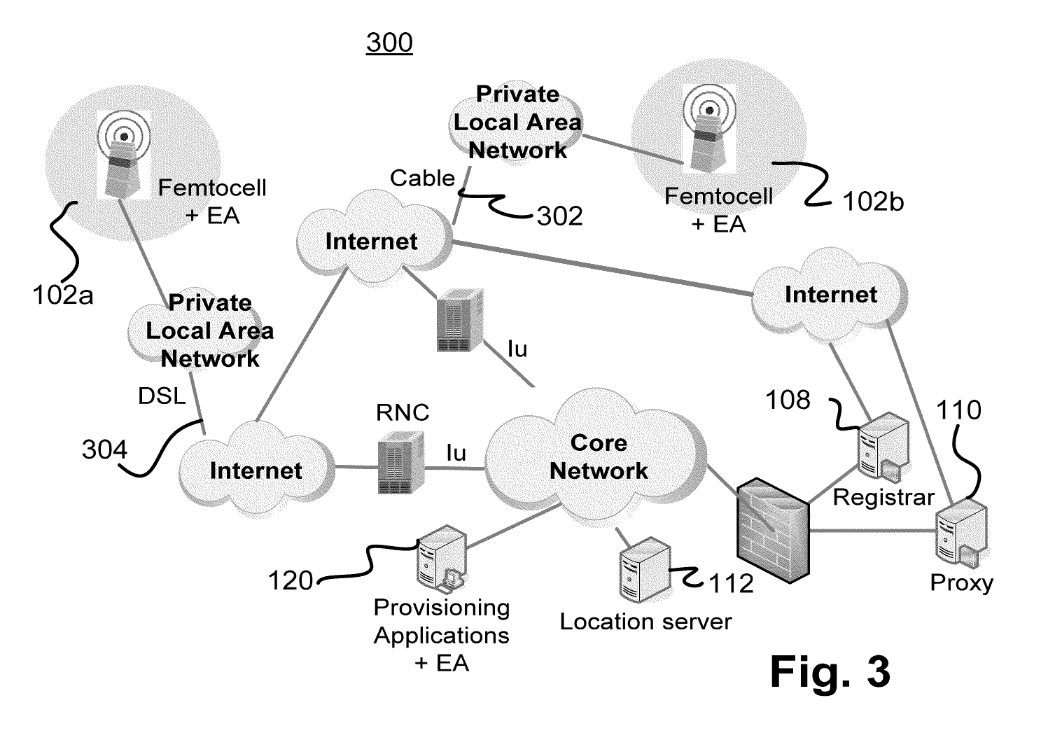

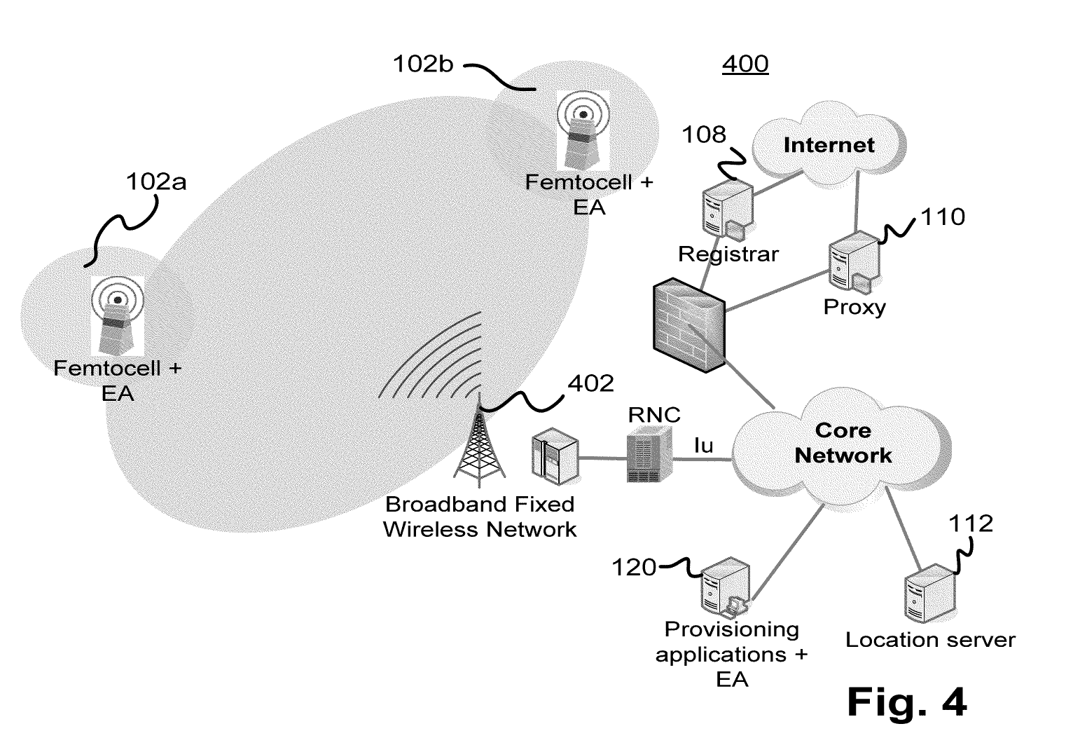

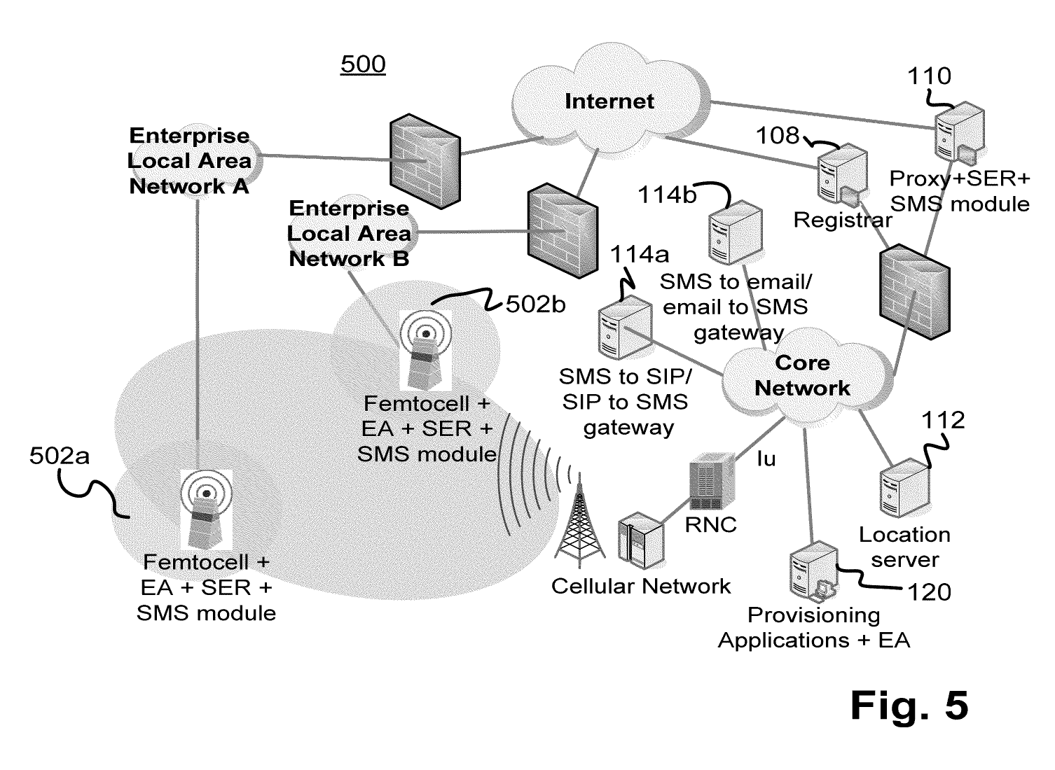

Embodiments of the present invention allow the network element to perform registration and discovery through five different network interfaces:
LAN 202, as shown in FIG. 2;
WAN (cable 302 or DSL broadband 304), as shown in FIG. 3;
Fixed wireless 402, as shown in FIG. 4;
Cellular data network 500, as shown in FIG. 5; and
Cellular SMS network, as shown in FIG. 5.

In operation, the embodiments of the present invention use the session initiation protocol (SIP) or functional equivalent session layer protocol and an Internet protocol (IP) backhaul to establish a common platform for network operation administration management and provisioning (OAM&P). Consequently, all the network operators can implement their own OAM&P applications on generic servers that support session layer protocol (e.g. SIP) and TCP/IP without having to worry about the proprietary operating systems, network topologies, and network interfaces. Given the common platform, instead of adapting equipment vendors' proprietary OAM&P protocol, the network operators are able to define and standardize the OAM&P requirements for the network elements. As a result, the network operators are able to request the equipment vendors to meet network operators' OAM&P requirements to establish a unified OAM&P environment based on the common platform layout provided by embodiments of the present invention and allow plug-and-play (e.g. femtocell), peer/client/server discovery, peer/client/server communication.

The key components to establish the common platform can be grouped into three parts—core components, network edge components and application components.

The core components include:
Element agent 106;
Registrar 108;
Proxy server 110;
Location server 112.

These are common components that always available in the network. Their main functions include:
Network element registration
Network element location tracking
OAM&P application signaling routing
Facilitate server discovery
Facilitate client discovery
Facilitate peer discovery
Facilitate session establishment.

The edge components include:
TCP/IP router supporting Network Address Translation and Port Mapping Protocol (NAT-PMP);
NAT transversal and application level gateway;
Dynamic DNS server;
DNS update client;
Cellular UE module;
SMS gateway.

In operation, these components are used to bridge two networks. For example, TCP/IP router supporting NAT-PMP, NAT transversal and application level gateway, Dynamic DNS server and DNS update client are needed to bridge private TCP/IP Local Area Network (LAN) and operator's core network. Cellular UE module and SMS gateway are needed to bridge cellular SMS network and operator's core network.

The application components are OAM&P servers. These components should be defined and implemented by network operators. The only requirements are to comply to the session layer protocol in operation (e.g. SIP). The details of these components are implementation specific and therefore beyond the scope of this application.

The registration serves multiple purposes, such as notifying network management server of the existence of a network element, establishing routine path(s) for network management signals and allowing peer discovery by other network elements.

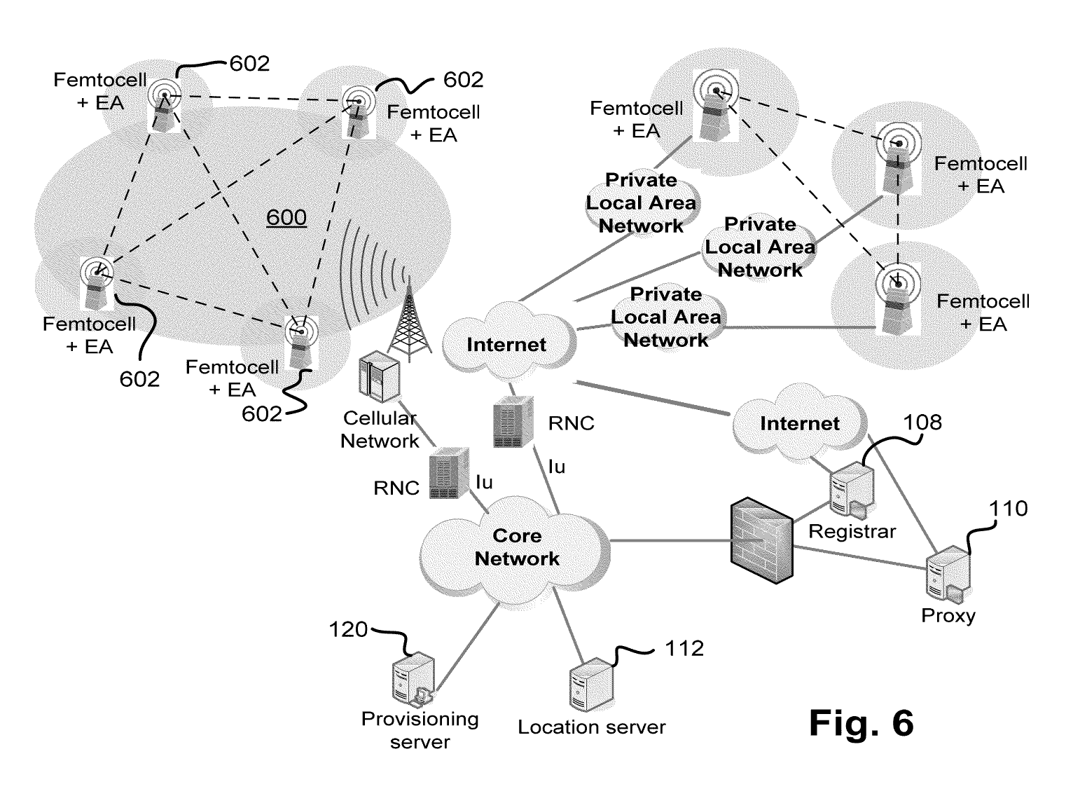

Referring to FIG. 6 there is illustrated a session based self-organized and/or self-coordinated network 600 in accordance with a fifth embodiment of the present invention. The embodiment allows a network element 602 to look up its peers to establish a peer-to-peer connection to form self-organized and/or self coordinated network.

The embodiments of the present invention allow the network management applications to send the management signals to network elements that are in managing mode. The embodiments provide a single session layer protocol based API that allows the implementation of the network applications independent of RAT, coverage footprints, transmission network topologies, network interfaces, signaling mechanisms, locations and equipment vendors.

In the client-server transaction model, the embodiments of the present invention allow the either the server (i.e. network management server) or client (i.e. network element) to initiate the communication provided both sides have registered with the registrar.

In the peer-to-peer transaction model, the embodiments of the present invention allow any network element (e.g. femtocell) compliant with the embodiments of the present invention to initiate communication with any other network element that is also compliant to the embodiments of the present invention provided the peers have registered with the registrar and discoverable.

The following figures illustrate the procedures for registration, authentication, peer discovery, provisioning and sending/receiving network management signals.

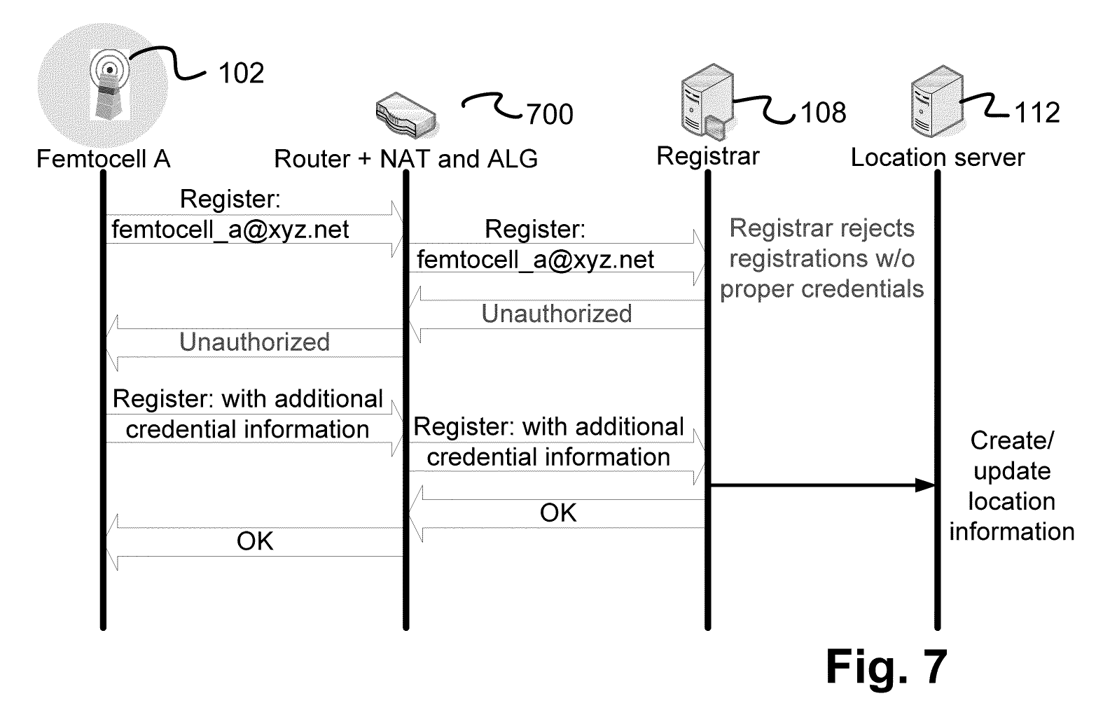

Referring to FIG. 7 there is illustrated a registration and authentication message sequence chart for a LAN/WAN interfaced network element of FIGS. 2 and 3. FIG. 7 illustrates the message sequence and signal traversal between the LAN/WAN interfaced network element (i.e. Femtocell A) 102 and the registrar server 108. Femtocell A 102 initiates the registration by sending the signal (i.e. registration request) to registrar 108 via the router 700. The NAT traversal and application level gateway in the router handles network address translation, if needed, and then routes the signal. Upon receiving the request, the registrar 108 authenticates the registration request and rejects the request if the authentication fails. Upon receiving the reject response, Femtocell A 102 resends the registration request with proper authentication information via the router 700. Registrar 108 receives the new request, authenticates the request and sends response back to Femtocell A 102. In the meantime, registrar 108 sends Femtocell A 102 location information (e.g. IP address, GPS locations etc.) to the location server 112.

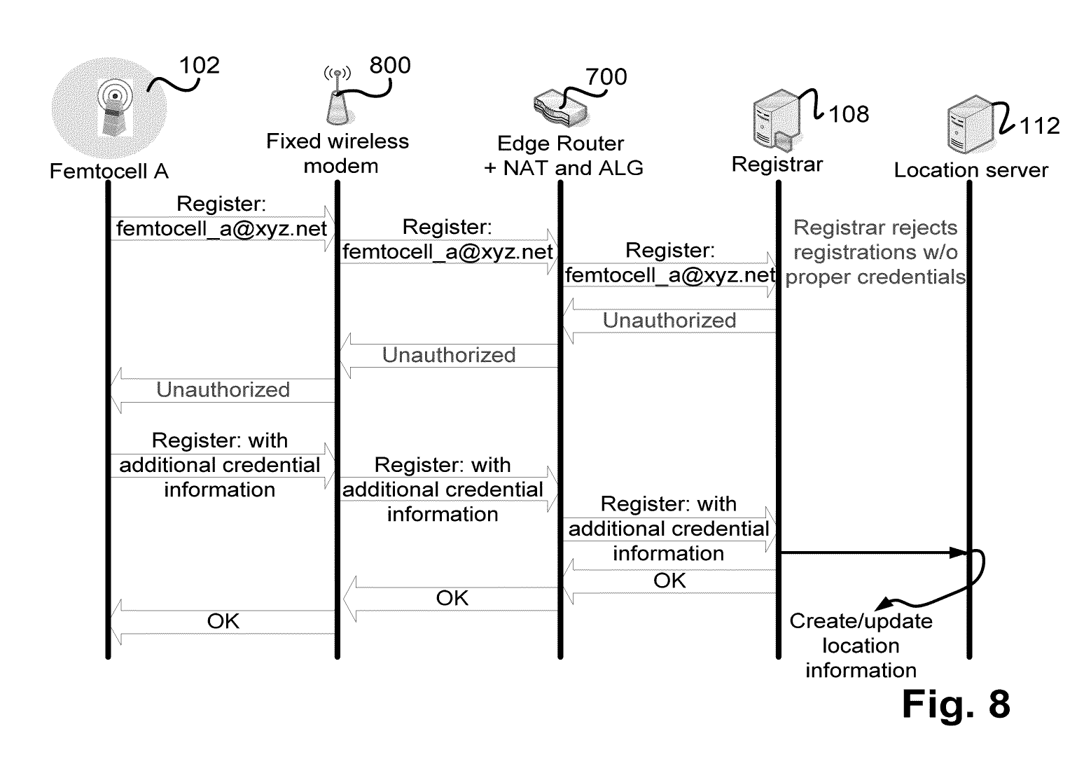

Referring to FIG. 8 there is illustrated a registration and authentication message sequence chart for a fixed wireless network or cellular data network interface network element of FIG. 4. FIG. 8 illustrates the message sequence and signal traversal between the fixed wireless network or cellular data network interfaced network element (i.e. Femtocell A) 102 and the registrar server 108.

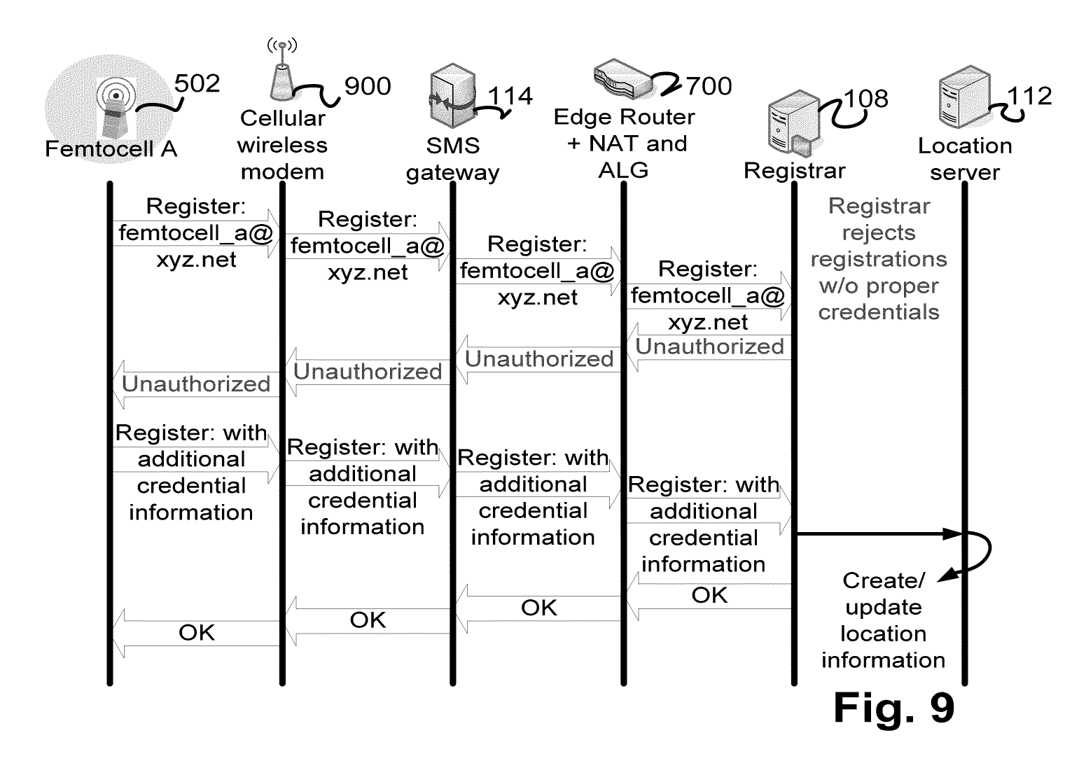

Referring to FIG. 9 there is illustrated a registration and authentication message sequence chart for a cellular SMS network interfaced network element of FIG. 5. FIG. 9 illustrates the message sequence and signal traversal between the cellular SMS network interfaced network element (i.e. Femtocell A) 502 and the registrar server 108.

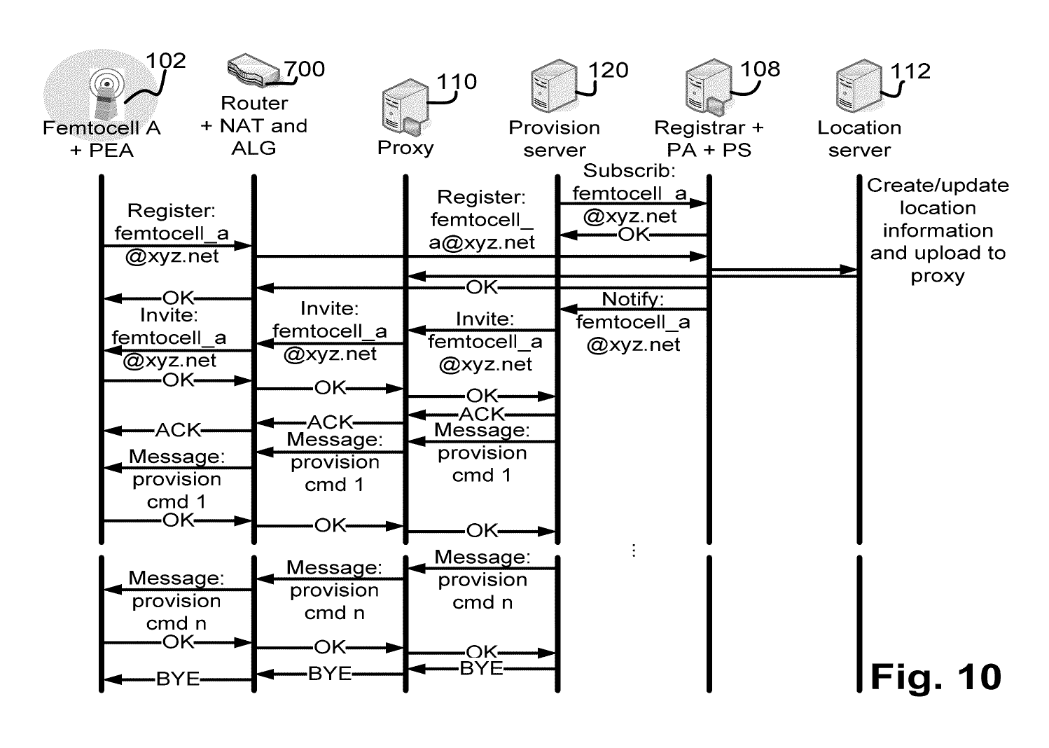

Referring to FIG. 10 there is illustrated a provisioning message sequence chart for a LAN/WAN interfaced network element of FIGS. 2 and 3. FIG. 10 illustrates the message sequence and signal traversal between the LAN/WAN interfaced network element 102 (i.e. Femtocell A) and the network management server 120 (i.e. provisioning server). The provisioning server 120 subscribes the Femtocell A's presence with registrar's Presence Server (PS) 108.

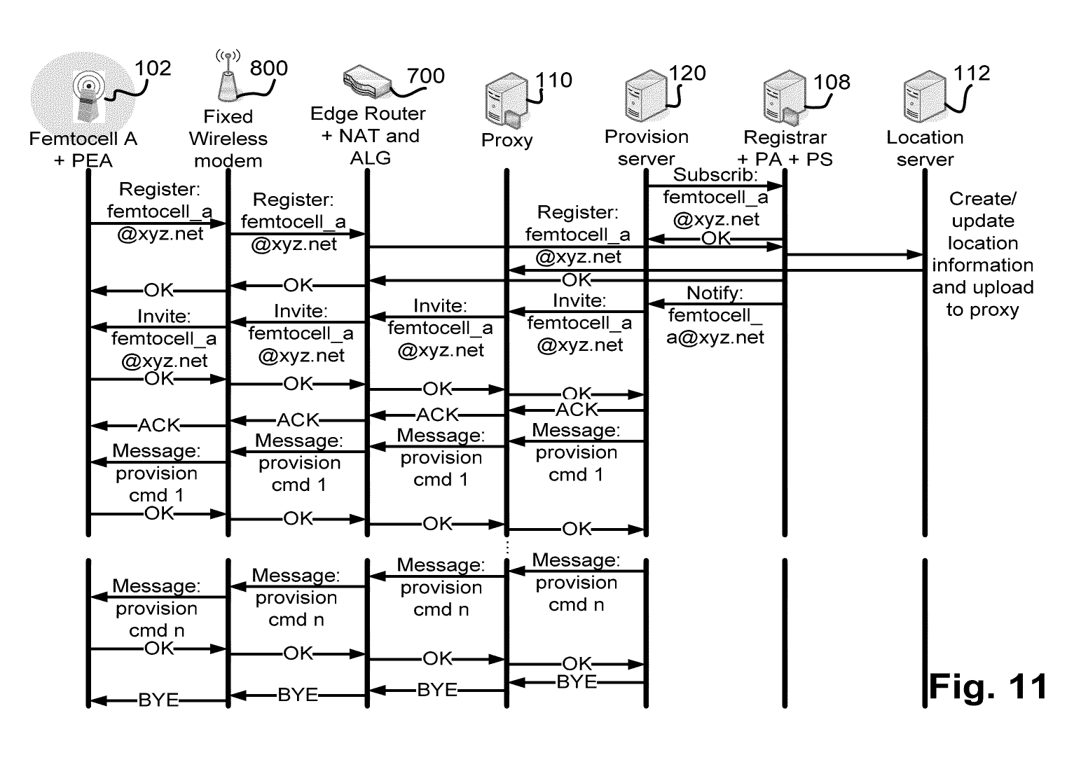

Referring to FIG. 11, there is illustrated a provisioning message sequence chart for a fixed wireless network or cellular data network interface network element 102 of FIG. 4. FIG. 11 illustrates the message sequence and signal traversal between the fixed wireless or cellular data network interfaced network element 102 and the network management server 120 (i.e. provisioning server).

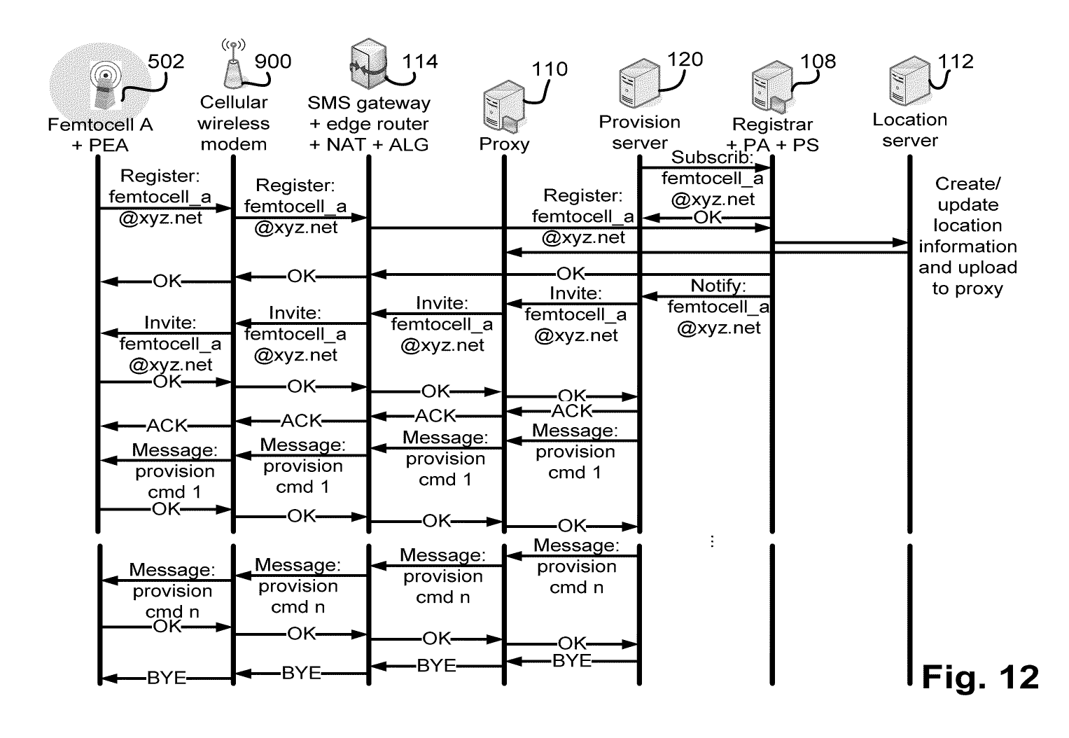

Referring to FIG. 12 there is illustrated a provisioning message sequence chart for a cellular SMS network interfaced network element 502 of FIG. 5. FIG. 12 illustrates the message sequence and signal traversal between the cellular SMS network interfaced network element 502 and the network management server 120 (i.e. provisioning server).

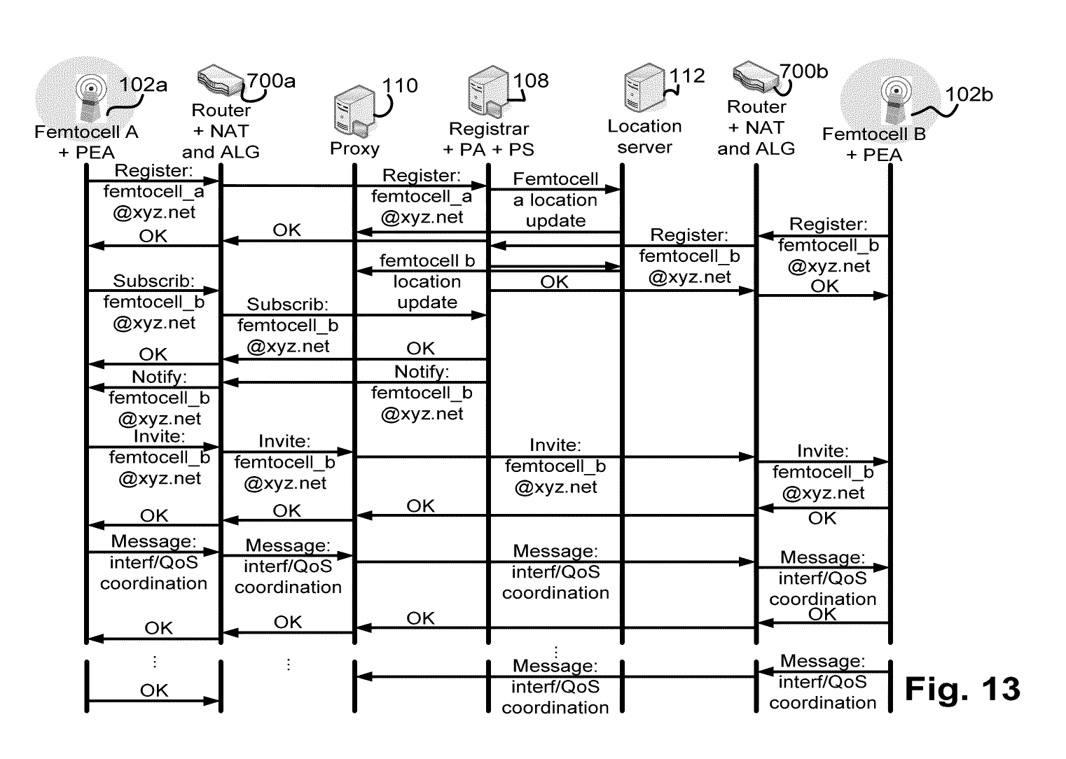

Referring to FIG. 13 there is illustrated a discovery message sequence chart for a LAN/WAN interfaced network elements 102a and 102b of FIGS. 2 and 3. FIG. 13 illustrates the peer discovery message sequence and signal traversal among the two femtocells 102a and 102b and the Presence Server (PS) 108. Femtocell A (102a) initiates the registration by sending registration request to registrar 108 via the router 700a. The NAT traversal and application level gateway in the router handles network address translation, if needed, and then routes the signal. Femtocell B (102b) initiates the registration by sending registration request to registrar 108 via the router 700b. The NAT traversal and application level gateway in the router handles network address translation, if needed, and then routes the signals. Upon receiving registration request, the registrar server 108 handles the requests and updates Femtocell A and B's location with location server 112 and PS 114. Upon completion of the registration. The Presence element Agent (PEA) within Femtocell A subscribes to Femtocell B's presence by sending subscribe request to Presence Agent (PA). Since Femtocell B has already registered and is present, the PA sends Femtocell B presence notification to PEA within Femtocell A. Once Femtocell B is successfully discovered, Femtocell A can send invitation to Femtocell B to establish peer-to-peer session for interference/QoS coordination etc.

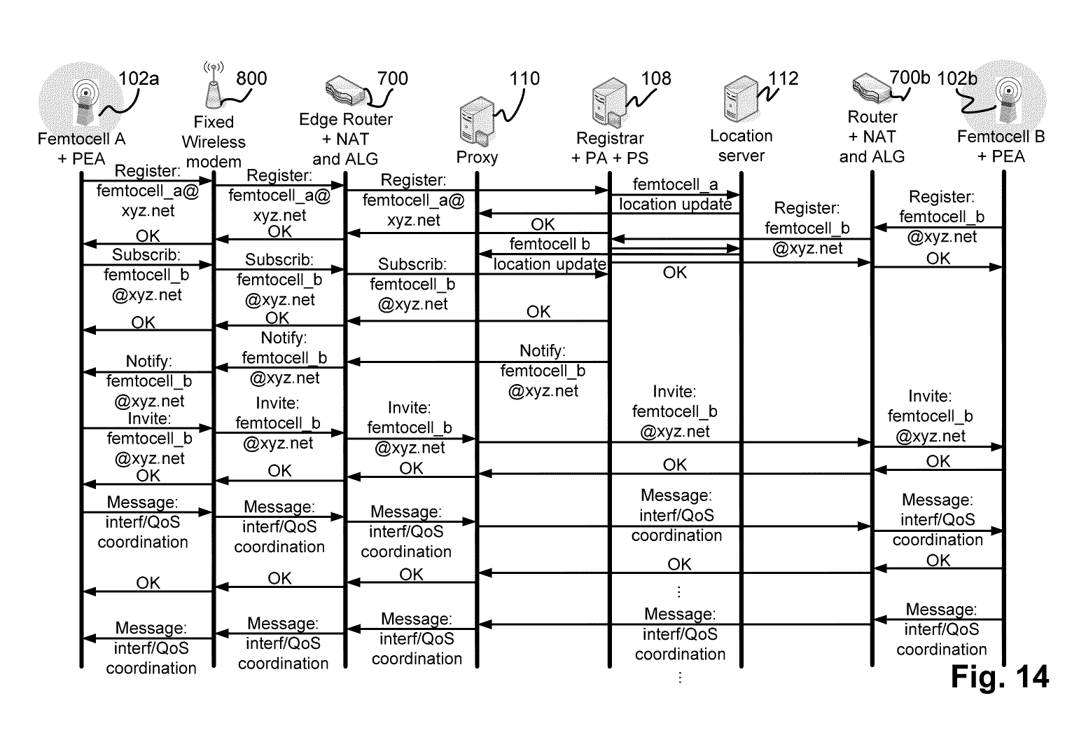

Referring to FIG. 14 there is illustrated a discovery message sequence chart for a fixed wireless network or cellular data network interface network elements 102a and 102b of FIG. 4. FIG. 14 illustrates the peer discovery sequence and signal traversal among the two femtocells and PS. Though Femtocell B illustrated in FIG. 14 is a LAN/WAN interfaced network element, it can be any kind of network interfaced network element, such as fixed wireless, cellular data network or cellular SMS network.

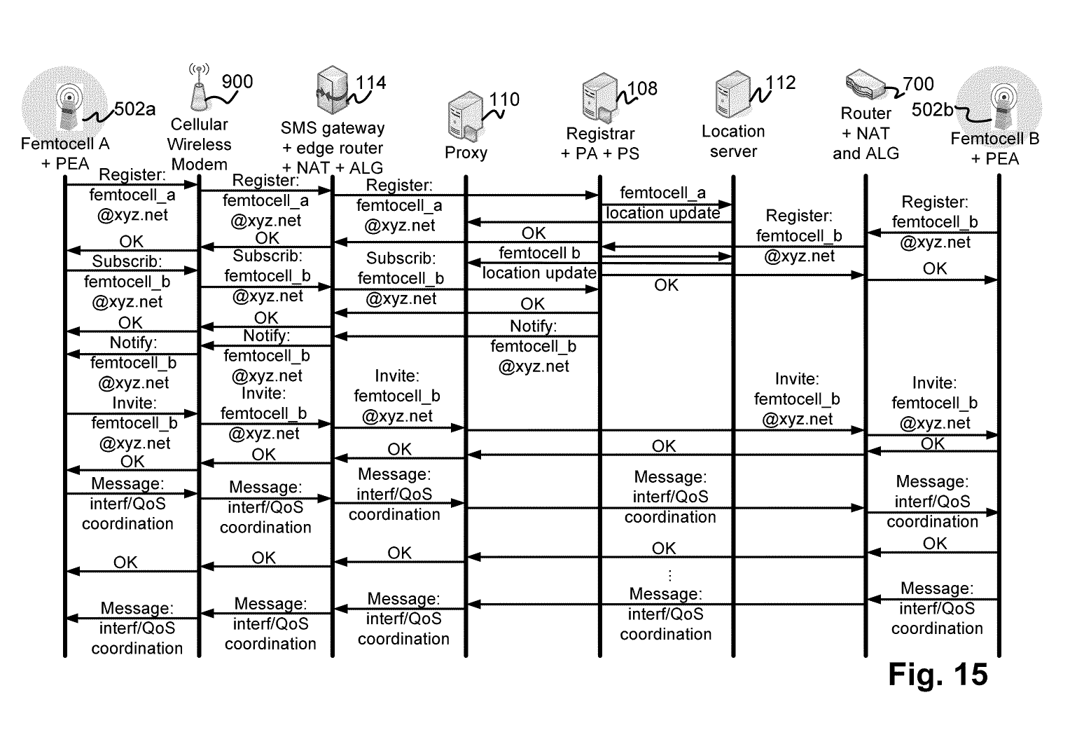

Referring to FIG. 15 there is illustrated a discovery message sequence chart for a cellular SMS network interfaced network elements 502a and 502b of FIG. 5. FIG. 15 illustrates the peer discovery sequence and signal traversal among the two femtocells and PS. Though Femtocell B illustrated in FIG. 15 is a LAN/WAN interfaced network element, it can be any kind of network interfaced network element, such as fixed wireless, cellular data network or cellular SMS network.

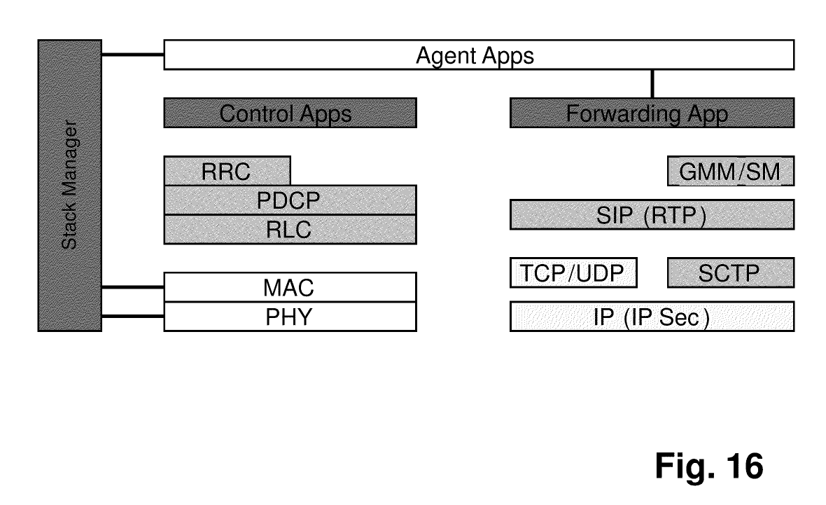

Referring to FIG. 16 there is illustrated a protocol stack in accordance with an embodiment of the present invention. The “Agent Apps” includes the EA and adaptation software. The adaptation software has two main components, protocol stack adaptation and application adaptation. The protocol stack adaptation handles the interface between the EA and the protocol stack(s), where the protocol stack(s) can be TCP/IP stack or wireless cellular protocol stack. The application adaptation handles the interface between the applications operating on the network work element, where the applications can be for example, a provisioning application, a software/firmware image management application, a status and performance monitoring application, a diagnostics application, an interference coordination/management application, a QoS coordination/management application.

The EA utilizes the protocol stack to transmit and receive packets via protocol stack adaptation software. The applications utilize the EA to communicate with the peers or servers via application adaptation software.

Numerous modifications, variations and adaptations may be made to the particular embodiments described above without departing from the scope patent disclosure, which is defined in the claims.

What is claimed is:

1. A system for operating, administering, managing and provisioning of a communications network comprising:
a network element in a first network;
for each network element, an element agent;
an interface between network elements in a first network;
an interface for coupling the first network to a second network; and
a registrar in the second network for registering each element agent.

2. The system of claim 1, wherein the registrar is a session layer protocol (e.g. SIP) compliant registrar.

3. The system of claim 1, wherein the interface between the network elements in the first network is via a local area network (LAN).

4. The system of claim 1, wherein the interface between the network elements in the first network is via a wide area network (WAN).

5. The system of claim 1, wherein the interface between the network elements in the first network is via a local fixed wireless network.

6. The system of claim 1, wherein the interface between the network elements in the first network is via a cellular data network.

7. The system of claim 1, wherein the interface between the network elements in the first network is via a cellular short message service (SMS) network.

8. The system of claim 1, wherein the interface between the network elements in the first network and the second network is via a local area network (LAN).

9. The system of claim 1, wherein the interface between the network elements in the first network and the second network is via a wide area network (WAN).

10. The system of claim 1, wherein the interface between the network elements in the first network and the second network is via a local fixed wireless network.

11. The system of claim 1, wherein the interface between the network elements in the first network and the second network is via a cellular data network.

12. The system of claim 1, wherein the interface between the network elements in the first network and the second network is via a cellular short message service (SMS) network.

13. A method of operating, administering, managing and provisioning of a communications network, the method comprising:
enabling each network element in a first network to communicate with another network element in the first network;
interfacing each network element in the first network with another network element in the first network; and
sending a message from a selected network element of the first network to another network element for at least one of operating, administering, managing and provisioning.

14. The method of claim 13, wherein the step of sending a message to another network element in the first network.

15. The method of claim 13, wherein the step of sending a message includes operating each network element in the first network.

16. The method of claim 13, wherein the step of sending a message includes administering each network element in the first network.

17. The method of claim 13, wherein the step of sending a message includes managing each network element in the first network.

18. The method of claim 13, wherein the step of sending a message includes provisioning each network element in the first network.

19. A method of operating, administering, managing and provisioning of a communications network, the method comprising:
enabling each network element in a first network to communicate with a server in a second network;
interfacing each network element in the first network with the second network; and
sending a message from a selected network element of the first network to the second network for at least one of operating, administering, managing and provisioning the selected network element.

20. The method of claim 19, wherein the step of sending a message includes registering each network element in the first network in a register of the second network

21. The method of claim 19, wherein the step of sending a message includes operating each network element in the first network using a register of the second network.

22. The method of claim 19, wherein the step of sending a message includes administering each network element in the first network using a register of the second network

23. The method of claim 19, wherein the step of sending a message includes managing each network element in the first network using a register of the second network

24. The method of claim 19, wherein the step of sending a message includes provisioning each network element in the first network using a register of the second network

25. The system of claim 19, wherein the register is maintained by a session layer protocol registrar.
